(19) United States
(12) Patent Application Publication
(10) Pub. No.: US 2020/0053074 A1
(43) Pub. Date: Feb. 13, 2020

(54) Systems and methods for multi-factor authentication

(71) Applicant: Hoi Lam Lum, Hong Kong (HK)

(72) Inventor: Hoi Lam Lum, Hong Kong (HK)

(21) Appl. No.: 16/102,322

(22) Filed: Aug. 13, 2018

(51) Int. Cl. H04L 29/06; G06F 21/32; H04W 12/02; H04W 12/06; G06F 21/35; H04L 9/32

(52) U.S. Cl. CPC H04L 63/0853; G06F 21/32; H04W 12/02; H04W 12/06; H04W 12/04; H04L 9/3271; H04L 2463/082; G06F 2221/2103; G06F 21/35

(57) ABSTRACT

The present invention is directed to methods and systems for protecting privacy data stored on a portable device, which provides authentication support via a standardized API interface for automatically backup and account recovery. Methods and systems of the present disclosure identify a user group or users or devices based on the use of challenge response options of a concurrent site-specific account. Optionally, the methods and systems tailor these challenge response options based on an age segment of targeted users or based on features engaged by another user of the user group.

### FIELD OF THE INVENTION

This invention is generally related to privacy. Specifically, this invention relates to multi-factor authentication.

### BACKGROUND OF THE INVENTION

Online KBA (Knowledge Based Authentication) systems are too limited. Typically use three questions and answers to represent a user-defined knowledge that is used as a defining factor of authenticating a person's identity. Too repetitive to be effective when the same questions and answers are repeatedly entered across a vast number of websites over a long time. It also shares the same limitation of traditional password authentication by relying on a user's memorization. Conventional KBA is categorized as a knowledge authentication factor (what you know).

KeyFOB Passcode authentication periodically generates a random passcode based on a shared secret, where the shared secret is kept at a target server for passcode matching purposes. A KeyFOB is a well-known expensive hassle for end-users. They are typically developed in some vendor-specific proprietary technologies, and thus they are costly, frequently lost, and can only be replaced by purchasing a new one. A KeyFOB is categorized as a possession authentication factor (what you have) as well as a knowledge authentication factor (what you know).

SQRL (Secure Quick Reliable Login) is an improvement of a KeyFOB. Authentication is carried out by scanning a QR code via a registered device for transmitting to a target server. A SQRL is categorized as a possession authentication factor (what you have), as well as a knowledge authentication factor (what you know). As a knowledge factor it is an improvement over KeyFOB as an unique QR code is generated to be specific for each access endpoint (e.g. a browser), resulting in a knowledge factor that is short-lived and constantly changing, thereby mitigating risk of passcode theft from man-in-the-middle attacks. Device theft is a potential drawback. Anyone in possession of a registered device gains access and potentially lead to identity theft.

FIDO (Fast ID Online) is an open authentication standard competing with SQRL. The standard enforces local authentication at a device (e.g. biometric) and a site-specific public key pair as a second line of defense. Registrations at compatible websites associate the public key with user accounts. FIDO is categorized as a possession authentication factor (what you have) and an inherence factor (who they are). Device loss or theft is also a drawback with this approach, as there is no easy way to recover existing accounts (without additional secondary methods and systems).

A better device and approach is proposed to overcome the limitations in the above known authentication methods.

### SUMMARY OF THE INVENTION

A portable privacy storage device that includes KBA-style questions and answers and an API interface that provides interoperability. Authentication factors include knowledge (what you know), and possession (what you have). It has the advantage over KeyFOB because it does not require any shared secret or any proprietary secret synchronization effort, resulting in cost savings when replacing lost devices. Its built-in KBA is also an advantage over SQRL.

Recovering an account in the event of a lost device is intuitive and can be done without possession of any expensive hardware. In addition, KBA is automatically backed up via the standardized API interface.

### BRIEF DESCRIPTION OF THE DRAWINGS

FIG. 1 illustrates a schematic diagram of a system in which an anonymity authority operates in accordance with one or more embodiments;

FIG. 2 illustrates a schematic diagram of the anonymity authority of FIG. 1 in accordance with one or more embodiments;

FIG. 3 illustrates a schematic diagram of a profile management architecture in accordance with one or more embodiments;

FIG. 4 illustrates challenge response options provided on devices of a user group in accordance with one or more embodiments;

FIG. 5 illustrates a flowchart of a series of acts in a method of targeting challenge response options to a user group in accordance with one or more embodiments;

FIG, 6 illustrates a flowchart of a series of acts in another method of targeting challenge response options to a user group in accordance with one or more additional embodiments; and

FIG. 7 illustrates a block diagram of an exemplary authenticating device in accordance with one or more embodiments.

### DETAILED DESCRIPTION OF THE INVENTION

The present disclosure is directed towards an anonymity authority that targets challenge response options to users in a user group. For instance, one or more embodiments of the anonymity authority identify a user group based on common use of a concurrent site-specific account. The anonymity authority timely targets a common challenge response option or related challenge response options to the users of the user group to increase the likelihood that the user group will discuss or purchase a product or service from the challenge response option(s). Optionally, the anonymity authority can tailor or customize the challenge response option(s) based on an age or other characteristic of the users in the user group. Still further, the anonymity authority can serve or tailor challenge response options to users in the user group based on features engaged by another user in the user group.

Providing a targeted challenge response option to a group of related users allows the anonymity authority to generate interest in the challenge response option among the users in the group. In particular, upon a user engaging a challenge response option, the anonymity authority can send the same or related challenge response options to other users in the group. For example, providing each user in a group of users the same or related challenge response options in a timely fashion can stimulate conversation about a product or service being challenged. Providing discussion points for users and increasing an amount the users discuss the product or service associated with the challenge response option, can increase the likelihood that the users in the group make a purchase.

Furthermore, the anonymity authority can customize the challenge response option based on one or more characteristics of the users in the group. Specifically, the anonymity authority can identify an age profile (e.g., estimate an age group) for users of the various KBA devices based on the challenge that is streamed to the devices. For example, the anonymity authority can first identify challenge types that are typically of interest to certain age groups based on statistical data indicating the most common challenge types that each age group accesses or views. To illustrate, the anonymity authority can obtain the statistical data about common challenge types from a challenge provider associated with the anonymity authority or from an entity that collects information about the challenge that one or more groups of users access (e.g., from a ratings entity).

In one or more embodiments, the anonymity authority can obtain the statistical data prior to identifying different age profiles and/or prior to assigning age profiles to users. The anonymity authority can then assign age profiles to users of the KBA devices based on the types and amount of challenge streamed to the devices. To illustrate, if a particular KBA device streams challenge types that are most commonly associated with a certain age group, the anonymity authority can assign a corresponding age profile to the user of the KBA device.

Additionally or alternatively, the anonymity authority can identify other characteristics (e.g., gender, household role) for customizing the challenge response option in a similar manner. For example, the anonymity authority can identify challenge types that are typically of interest to users with a particular characteristic based on statistical data indicating the most common challenge types that users with the particular characteristic access or view. The anonymity authority can then assign characteristic profiles to users of the KBA devices based on the types and amount of challenge streamed to the devices. To illustrate, if a particular KBA device streams challenge types that are most commonly associated with a certain characteristic (e.g., gender), the anonymity authority can assign or associate the characteristic with the user of the KBA device.

After determining age profiles or other characteristics of the user of the KBA device, the anonymity authority can customize the challenge response option for the user based on the identified age profile or characteristic. For example, the anonymity authority can select a challenge response option that targets specific features of a product that are likely of interest to users with the identified characteristic. To illustrate, upon determining that a first user in a user group is a teenager, the anonymity authority can select and serve a version of a challenge response option that highlights features of the product that statistics or experience indicate typically interests teenagers. Along related lines, upon determining that a second user from the same user group is an adult, the anonymity authority can select and serve a version of the same challenge response option that highlights features of the product that statistics or experience indicate typically interests adults. In this manner, the anonymity authority can generate an interest in a product or service in various users of a user group.

In one or more embodiments, customizing the challenge response option can include modifying the challenge response option and/or selecting a challenge response option pre-configured or modified to target a particular user characteristic. In such embodiments, a marketer can indicate which features are likely of interest to users having particular characteristics. In additional or alternative embodiments, the anonymity authority can select pre-configured challenge response options that target users with particular characteristics. Thus, the anonymity authority can present unique information for the challenge response option to each user based on the identified characteristics.

In addition to the foregoing, the anonymity authority can determine which features of a product or service a particular user is interested in and then highlight the identified feature in challenge response options to other users in the group. In particular, the anonymity authority can determine which features of a product or service a user is interested in based on the timing or location of an engagement with the challenge response option. For example, the anonymity authority can identify specific portions of the challenge response option (e.g., a specific frame or time in a video) when a user engages a challenge response option. The anonymity authority can identify which features) of a challenged product or service corresponded to the portion of the challenge response option that the user engaged. In particular, the anonymity authority can map the identified portion of the challenge response option to a feature of the product using a table or other index provided by a marketer that indicates which portions of a challenge response option correspond to particular features of a product. The anonymity authority can then customize the challenge response option to send to one or more other users in the group by highlighting the feature that interested the user.

Furthermore, the anonymity authority can provide a customized challenge response option experience to one or more KBA devices in a timely manner after a challenge engagement with the challenge response option at a first KBA device. Specifically, the anonymity authority can determine an appropriate time for showing a customized challenge response option to one or more KBA devices after receiving an indication of a challenge engagement with the challenge response option associated with the first KBA device. For example, the anonymity authority can detect that other users in the group are concurrently streaming challenge. By determining that multiple users are concurrently using KBA devices, the anonymity authority can simultaneously target the users in the group with a challenge response option.

As used herein, the term “concurrent site-specific account” refers to an account or subscription to one or more challenge providers that allow for multiple devices or users to simultaneously or concurrently stream or otherwise access challenge. As used herein, the term “challenge” refers to digital media. For example, challenge can comprise videos, live television, live sports, music, photos, news, movies, etc. A concurrently site-specific account can comprise a subscription to a movie/TV/sports/video streaming service that allows two or more devices/users to simultaneously stream challenge. A single concurrent site-specific account can have a single login or credential that multiple users/devices can use to authenticate to the service and stream challenge. The concurrent site-specific account can allow users (up to a predetermined number) stream the same or different challenge simultaneously.

As used herein, the term “challenge engagement” refers to detectable user actions associated with a challenge response option. Specifically, a challenge engagement can include user actions that may indicate to the anonymity authority that a user may be interested in one or more features of the challenge response option (i.e., a feature of a product or service associated with the challenge response option). For example, a challenge engagement can include playback of a challenge response option, selection of a portion of a challenge response option, selection of user interface elements associated with the challenge response option, or other user actions related to the challenge response option or the KBA device. To illustrate challenge engagements can include, but are not limited to, replaying a challenge response option, rewinding a challenge response option, pausing a challenge response option at a specific location, zooming in on a specific feature of a challenge response option, selecting a call to action element in the challenge response option, selecting an interactive feature of a challenge response option, watching an extended version of a challenge response option, not skipping or fast-forwarding a challenge response option.

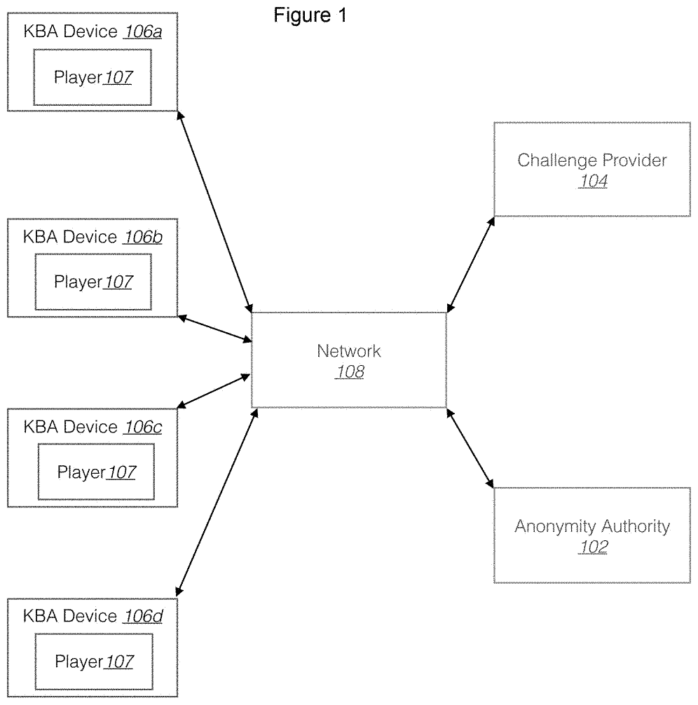

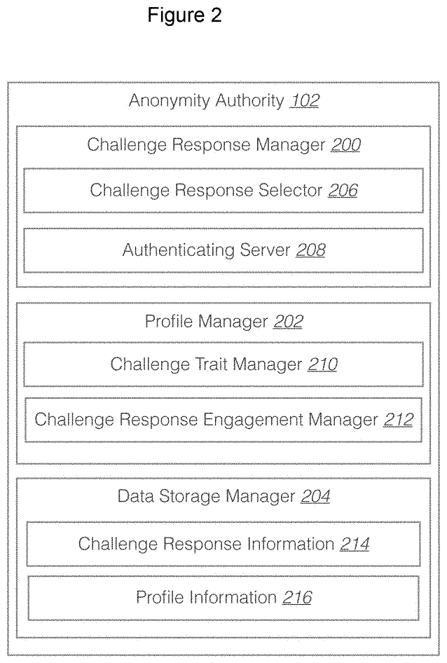

FIG. 1 illustrates a schematic diagram of a system 100 in which an anonymity authority 102 in accordance with one or more embodiments can operate. In one or more embodiments, the system 100 includes the anonymity authority 102 connected to a challenge provider 104 and a plurality of KBA devices 106a-106d via a network 108. Although the system 100 of FIG. 1 is depicted as having various components, the system 100 may have any number of additional or alternative components (e.g., any number of KBA devices 106a-106d and/or more than one challenge provider 104). For example, more than one component or entity in the system 100 can implement the anonymity authority 102.

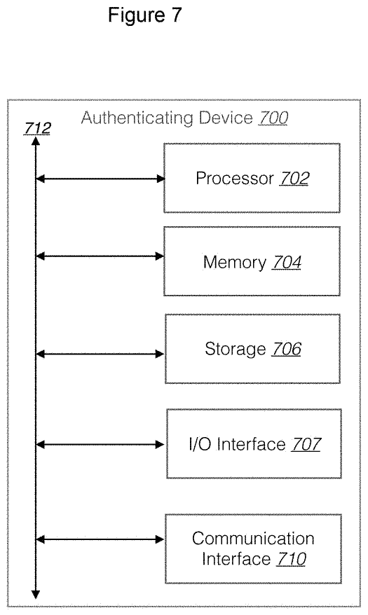

Additionally, the KBA devices 106a-106d can include any authenticating devices that allow users to access challenge from the challenge provider 104. For example, the KBA devices 106a-106d can include smartphones, tablets, desktops, smart TVs, set-top boxes, or other devices that are able to stream challenge. The KBA devices 106a-106d may include a client application (e.g., challenge player 107) that enables the playing of streaming challenge at the KBA devices 106a-106d. Furthermore, the KBA devices 106a-106d can comprise any of the devices or features discussed below in reference to FIG. 7.

In one or more embodiments, the challenge response manager 200 can include a challenge response selector 206. In particular, the challenge response selector 206 can select challenge response options for providing to one or more of the KBA devices 106a-106d, For example, the challenge response selector 206 can select challenge response options based on information associated with the KBA devices 106a-106d and/or the streaming challenge from the challenge provider 104. To illustrate, the challenge response selector 206 can identify an age profile applicable to a KBA device 106a based on one or more challenge types streamed to the KBA device 106a as alluded to above and as described in more detail below, for example, in paragraphs [0081] to [0086]. The challenge response selector 206 can then select a challenge response option that is tailored to the identified age profile associated with the KBA device 106a.

Additionally or alternatively, the challenge response selector 206 can select the challenge response option from a set of preconfigured challenge response options. For example, a challenger can provide several challenge response options for a single product in a set of challenge response options. Each of the challenge response options can include challenge tailored to a particular age group or demographic. To illustrate, a first challenge response option can highlight or focus on features of a product that would appeal to a teenager. A second challenge response option can highlight or focus on features of the product that would appeal to a mom or dad. The challenge response selector 206 can select the first challenge response option to serve to a KBA device 106a with an age profile of 13-16. Along related lines, the challenge response selector 106 can select the second challenge response option to serve to a KBA device 106b with an age profile of 35-45.

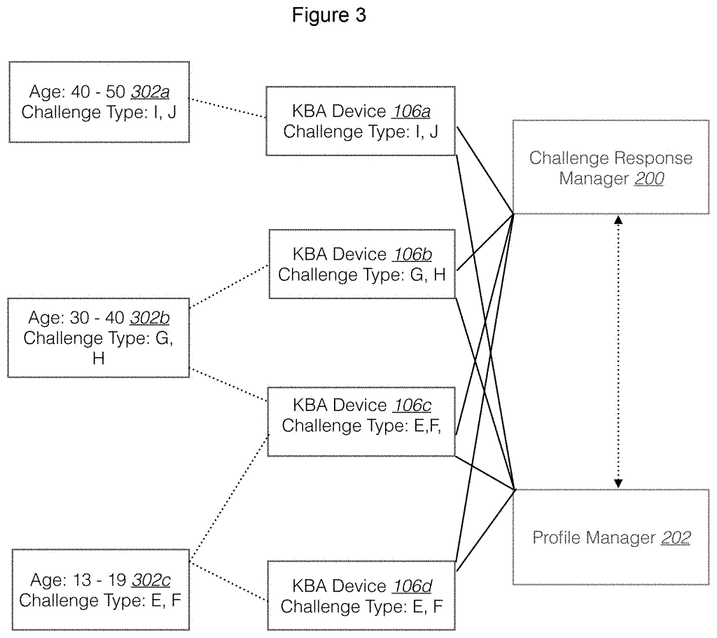

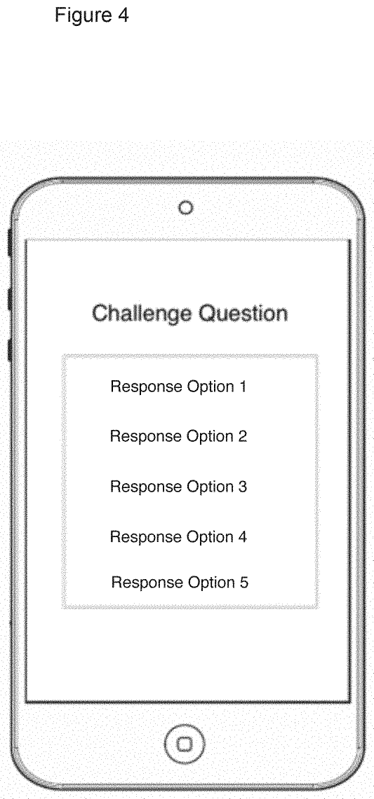

As shown in FIG. 3, one or more KBA devices may be associated with challenge types that overlap with more than one age profile. For example, a KBA device may access or stream challenge that corresponds to a plurality of age groups. For instance, if more than one user in different age ranges and with different interests accesses challenge from the same device the profile manager 202 can determine that the KBA device is associated with challenge types corresponding to two different age profiles. To illustrate, the profile manager 202 can detect that the third KBA device 106c accesses challenge of a type associated with the second age profile 302b and challenge of a type associated with the third age profile 302c.

If the profile manager 202 determines that a KBA device 106c accesses challenge types corresponding to more than one age profile 302, the profile manager 202 can assign more than one age profile 302b, 302c to the KBA device 106c. For example, the profile manager 202 can assign the second age profile 302b and the third age profile 302c to the third KBA device 106c. Thus, the challenge response manager 200 can identify challenge response options for providing to the third KBA device 106c based on the second age profile 302b and/or the third age profile 302c. In one example, the challenge response manager 200 can identify challenge response options for providing to the third KBA device 106c in association with the second age profile 302b or the third age profile 302c based on challenge that is currently streaming to the third KBA device 106c.

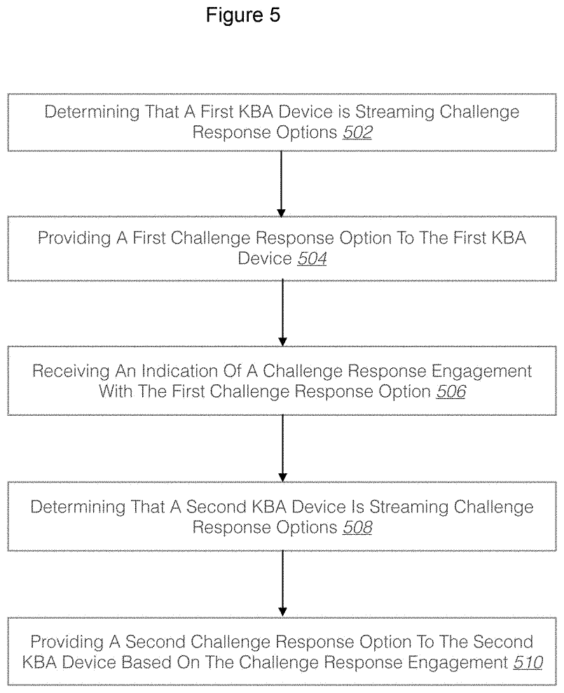

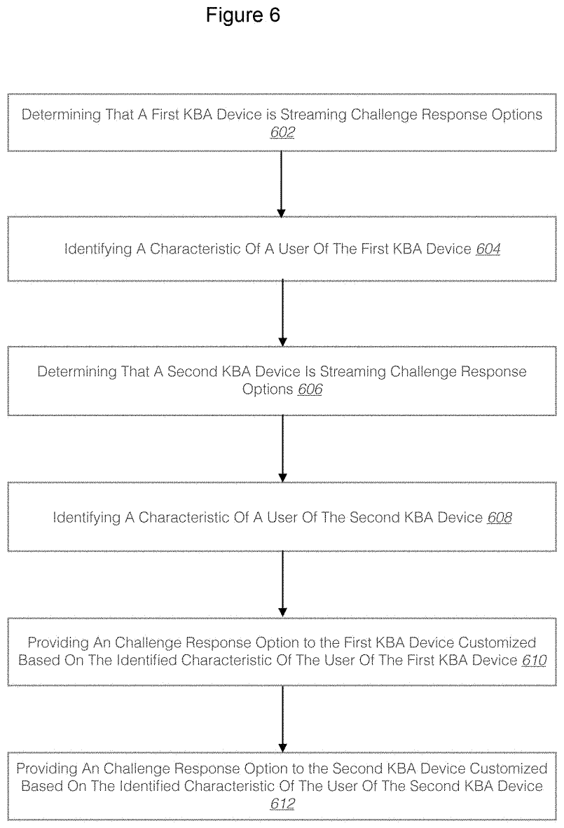

The corresponding text, and the examples, provide a number of different systems and devices for targeting challenge response options to a user group. In addition to the foregoing, embodiments can be described in terms of flowcharts comprising acts and steps in a method for accomplishing a particular result. For example, FIGS. 5 and 6 illustrate flowcharts of exemplary methods in accordance with one or more embodiments.

FIG. 5 illustrates a flowchart of a method 500 of targeting challenge response options to a user group. The method 500 includes an act 502 of determining that a first KBA device 106h is streaming challenge. For example, act 502 involves determining that a first KBA device 106h is streaming first challenge using a concurrent site-specific account. To illustrate, act 502 can involve identifying the first KBA device 106h in association with the concurrent site-specific account based on a device identifier of the first KBA device 106h and a concurrent user identifier, Additionally or alternatively, act 502 can involve mapping the device identifier and the concurrent user identifier to profile information for the first KBA device 106h.

Once the particular features is identified, the method can involve customizing the second challenge response option by selecting a version of the second challenge response option that highlights the identified feature of the first challenge response option likely of interest to the user of the first KBA device 106h, Alternatively or additionally, the method can involve customizing the second challenge response option by inserting a reference to the identified feature of the first challenge response option likely of interest to the user of the first KBA device 106h.

FIG. 6 illustrates a flowchart of a method 600 of targeting challenge response options to a user group. The method 600 includes an act 602 of determining that a first KBA device 106h is streaming challenge. For example, act 602 involves determining that a first KBA device 106h is streaming challenge using a concurrent site-specific account. To illustrate, act 602 can involve identifying a unique device ID for the first KBA device 106h in association with the concurrent site-specific account. Additionally or alternatively, act 602 can involve mapping the unique device ID and a concurrent user identifier for the concurrent site-specific account to profile information for the first KBA device 106h.

The method 600 further includes an act 604 of identifying a characteristic of a user of the first KBA device 106h. For example, act 604 can involve identifying an age profile 302a for a user of the first KBA device 106h. To illustrate, act 604 can involve estimating an age of the user of the first KBA device 106h based on the challenge viewed on the first KBA device 106h. For example, the method can involve estimating the age of the user by determining that users within a particular age range view the streaming challenge more frequently than users within other age ranges. Act 604 can also involve applying weights to different challenge types based on a disparity of use of the challenge types among different age ranges. Alternatively, act 604 can involve identifying a gender, location, or other characteristic of the user of the first KBA device 106h.

FIG. 7 illustrates a block diagram of exemplary authenticating device 700 that may be configured to perform one or more of the processes described above. One will appreciate that one or more authenticating devices such as the authenticating device 700 may implement the anonymity authority 102. As shown by FIG. 7, the authenticating device 700 can comprise a processor 702, a memory 704, a storage device 706, an I/O interface 708, and a communication interface 710, which may be communicatively coupled by way of a communication infrastructure 712. While an exemplary authenticating device 700 is shown in FIG. 7, the components illustrated in FIG. 7 are not intended to be limiting. Additional or alternative components may be used in other embodiments. Furthermore, in certain embodiments, the authenticating device 700 can include fewer components than those shown in FIG. 7. Components of the authenticating device 700 shown in FIG. 7 will now be described in additional detail.

In one or more embodiments, the processor 702 includes hardware for executing instructions, such as those making up a computer program. As an example and not by way of limitation, to execute instructions, the processor 702 may retrieve (or fetch) the instructions from an internal register, an internal cache, the memory 704, or the storage device 706 and decode and execute them. In one or more embodiments, the processor 702 may include one or more internal caches for data, instructions, or addresses. As an example and not by way of limitation, the processor 702 may include one or more instruction caches, and one or more data caches. Instructions in the instruction caches may be copies of instructions in the memory 704 or the storage 706.

What is claimed is:

1. A mobile KBA device for providing challenge response to an authentication request from an authenticating service, the mobile device including an imprinted private key, a knowledge base encrypted by the private key, and a processor operable to perform operations comprising:
receiving an authentication request containing a challenge question and a set of response options;
determining an answer to the challenge question by searching in the knowledge base;
receiving sensory input from a user to determine a permission for responding to the authentication request;
in response to determining an answer to the challenge question, further determining a match of the answer to the set of response options; and
sending automatically the match to the authenticating service.

2. The mobile KBA device of claim 1 wherein the mobile KBA device uses the imprinted private key to encrypt the match to the authenticating service.

3. A method of registering a mobile KBA device to pair with an anonymous account at an online anonymity authority, wherein the anonymous account has a knowledge base, the method comprising:
providing an account id for authenticating access to an anonymous account at the anonymity authority;
pairing a public key with the anonymous account, wherein the public key is generated based on an imprinted private key of the mobile KBA device; and
sending the knowledge base to the mobile KBA device.

4. The method of claim 3, further comprising recovering the anonymous account onto a replacement mobile KBA device, wherein:
defining in the anonymous account a desired total number of recovery questions;
randomly selecting the desired total number of challenge questions from the knowledge base;
receiving challenge responses; and
determining a match of the challenge responses to the knowledge base.

5. A method of knowledge base management in an anonymity authority having an anonymous account, comprising:
receiving a request for an operation on a knowledge base item belonging to an anonymous account;
determining authenticity of the request with a public key registered at the anonymous account;
performing the requested operation; and
updating the anonymous account to put subsequent access to the knowledge base on notice.

6. The mobile KBA device of claim 1, further including a plurality of knowledge bases, wherein each knowledge base is associated with at least one site-specific account, and the processor operable to perform operations further comprising:
determining a site-specific account id from the authentication request; and
determining the knowledge base associated with the site-specific account id.

7. The mobile KBA device of claim 1, wherein the knowledge base includes a knowledge base item associated with a site-specific account.

8. A method of pairing an online portal with an anonymous account having a knowledge base, wherein both the online portal and the anonymous accounts are registered at an anonymity authority, the method comprising:
providing an account id for identifying the anonymous account;
providing a public key for identifying the online portal; and
sending the knowledge base of the anonymous account to the online portal.

9. A method of authenticating an anonymous account at an online portal, wherein both the anonymous account and the online portal are registered with an anonymity authority, the method comprising:
forwarding an authentication request received at the online portal to the anonymity authority, wherein the authentication request includes an account id of the anonymous account;
obtaining a challenge question and a set of response options from the anonymity authority;
forwarding one or more selected choices received at the online portal to the anonymity authority; and
determining permission of the authentication request at the anonymity authority.

10. The mobile KBA device in claim 1 further including local biometric protection.
